(19) United States
(12) Patent Application Publication
(10) Pub. No.: US 2012/0018996 A1
(43) Pub. Date: Jan. 26, 2012

(54) SEAL ARRANGEMENT, METHOD FOR MANUFACTURING SUCH A SEAL ARRANGEMENT AND DISHWASHER

(75) Inventor: Hermann Stempfle, Glott (DE)

(73) Assignee: BSH BOSCH UND SIEMENS HAUSGERATE GMBH, Munich (DE)

(21) Appl. No.: 13/178,540

(22) Filed: Jul. 8, 2011

(30) Foreign Application Priority Data
Jul. 20, 2010 (DE) 10 2010 031 559.1

(51) Int. Cl. F16L 41/08; F16L 33/00

(52) U.S. Cl. 285/141.1; 277/314

(57) ABSTRACT

A seal arrangement for a liquid-tight connection of a connection opening of a liquid-conducting component to a connection piece of a liquid flow device includes a sealing element which is provided in a ring gap that separates the connection piece from an edge of the connection opening. The sealing element has a radially inner sealing point in sealing contact with the connection piece and a radially outer sealing point in sealing contact with the edge of the connection opening.

### BACKGROUND OF THE INVENTION

The invention relates to a seal arrangement for a liquid-tight connection between a connection opening of a liquid-conducting component, especially of a washing container of a dishwasher, and a connection piece of a liquid flow device, especially a recirculation pump, as well as to a method for manufacturing such a seal arrangement.

In household appliances, especially in dishwashers, water-conducting units are often connected to the washer container by means of liquid-tight sealing elements.

In a dishwasher for example a seal arrangement can typically be connected between a pressure piece of a recirculation pump and an inlet connection of a washing container or a pump sump. The seal arrangement can consist of a hose-like sealing element made of soft rubber material which is pushed onto both the inlet connection of the washing container and also onto the pressure piece of the recirculation pump. The hose-like sealing element is thus in sealing contact with the inlet connection of the washing container and the pressure piece of the recirculation pump respectively.

In the area of the sealing points between the sealing element and the inlet or pressure piece the sealing element is strengthened with outer ring sleeves which can be embodied from a dimensionally-stable plastic material rigid by comparison with the rubber material. In this way a predetermined compression force is applied to the soft rubber material in the sealing points.

During dishwashing overpressure is applied to the interior space of the washing container or the pump sump, which acts on the sealing element with a pushing force against the installation direction. For stable retention the sealing element is thus gripped by attachment clamps in the area of its sealing points. The seal arrangement can thus have a number of separate components which can only be installed with some effort.

### BRIEF SUMMARY OF THE INVENTION

It is an object of the invention to provide a seal arrangement or a method for manufacturing such a seal arrangement in which the number of components can be reduced and which is also easy to install.

The object is achieved by the features and preferred developments of the invention as disclosed in the claims.

The sealing element has a radial inner sealing point and also a radial outer sealing point. The radial outer sealing point of the sealing element is in sealing contact with the edge of a connection opening of a liquid-conducting component, such as a dishwasher washing container. The sealing element is also in sealing contact with its radially inner sealing point with the inside connection piece of a liquid flow device, such as a recirculation pump for example. In this way the sealing element, in terms of installation, can be easily pressed into the ring gap between the connection opening edge and also the connection piece. Additional clamps are not required in this case.

For a reliable seal the edge of the connection opening can be delimited by an approximately cylindrical ring wall. The ring wall can be in sealing contact over a large surface area with the outer sealing point of the sealing element.

As already mentioned above, the sealing element can be made of a soft rubber material. To increase its dimensional stability the sealing element can feature additional support elements, especially retaining rings or ring sleeves, with the aid of which the sealing element can be pressed in the area of its sealing points against the edge of the connection opening or against the connection piece respectively.

The two sealing points of the sealing element can be connected to each other by an equalization section, especially by a bellows section. The bellows section can especially be embodied in the form of a corrugated section. It can compensate for installation-related tolerances. In addition the bellows section can reduce transmission of vibrations between the liquid flow unit, such as the recirculation pump, and the water-conducting component, such as the washing container.

For simple and precisely-positioned assembly of the sealing element the edge of the connection opening and/or the connection piece can be embodied with a movement stop, especially a ring stop, against which the sealing element can be pressed.

Preferably the sealing element with its two sealing points can be pushed in a common assembly direction onto the edge of the connection opening and onto the connection piece until both sealing points are stopped by the above-mentioned movement stops.

For a smooth assembly movement the connection piece is pre-positioned exactly in relation to the connection opening in a pre-assembly step. In this case the connection piece can project in a first variation at least partly into the connection opening of the water-conducting component. Depending on the situation with regard to installation space, the connection piece can also be arranged offset in height at a distance outside the water-conducting component. The sealing element can be adapted to both installation positions with the above-mentioned equalization section.

In the event of the sealing element being pushed into a ring gap between the connection opening edge and the connection piece, starting from an interior space, in the installation position the sealing element is exposed to the interior of the water-conducting component. Where a washing container is used as the water-conducting component its interior is pressurized during dishwashing. The liquid column in the interior thus presses with excess pressure on the exposed sealing surfaces of the sealing element.

Unlike in the prior art, in accordance with the invention no pushing force is created which promotes the working loose of the sealing element from the connection opening or from the connection piece. Instead, in accordance with the invention, the sealing element is pressed in the area of its sealing points against the two movement stops as well as against the edge of the connection opening, which causes the sealing between the connection piece and the connection opening edge to be strengthened even further.

The invention also relates to a dishwasher having at least one inventive seal arrangement.

Other advantageous developments of the invention are described in the subclaims.

### BRIEF DESCRIPTION OF THE DRAWINGS

The invention and its embodiments and developments and their advantages will be explained in greater detail below with reference to drawings, in which the respective drawings show the following schematic diagrams:

FIG. 1 a basic diagram of a dishwasher;

FIG. 2 in an enlarged sectional diagram, a seal arrangement between a pressure piece of a recirculation pump and also a connection opening in the washing container floor of the dishwasher;

FIG. 3 a sectional diagram from the side to illustrate the assembly of the seal arrangement; and

FIG. 4 in a view corresponding to that shown in FIG. 3, a variation of the seal arrangement.

### DETAILED DESCRIPTION OF EXEMPLARY EMBODIMENTS OF THE PRESENT INVENTION

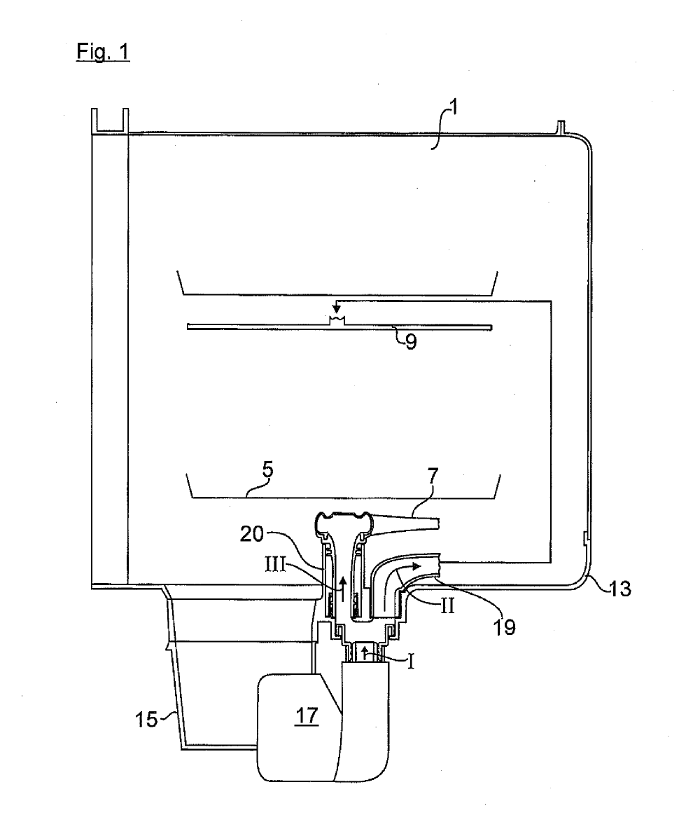

FIG. 1 shows an outline schematic diagram of a dishwasher with a washing container 1, in which items to be washed not shown in the diagram can be arranged in crockery baskets. In the washing container 1 shown spray arms 7, 9 are provided at two different levels, with which washing liquor is applied to items to be cleaned. The device components of the dishwasher and also the washing operation are only described below to the extent to which they are of importance for understanding the invention.

In accordance with FIG. 1 a recirculation pump 17 is provided below a washing container floor 13 next to its pump sump 15, which guides washing liquor in the hydraulic circuit of the dishwasher via fluid lines 19, 20 to the spray arms 7, 9. Viewed upstream of the recirculation pump 17, the washing liquor flow I displaced from the recirculation pump 17 during the washing cycle is divided up into two part flows II, III which are guided via the lines 19, 20 to the upper and lower spray arm 7, 9. The recirculation pump 17 can have a water switch not shown in greater detail here connected downstream from it, which releases the part flows II and II alternately in time to the spray arms 19, 20.

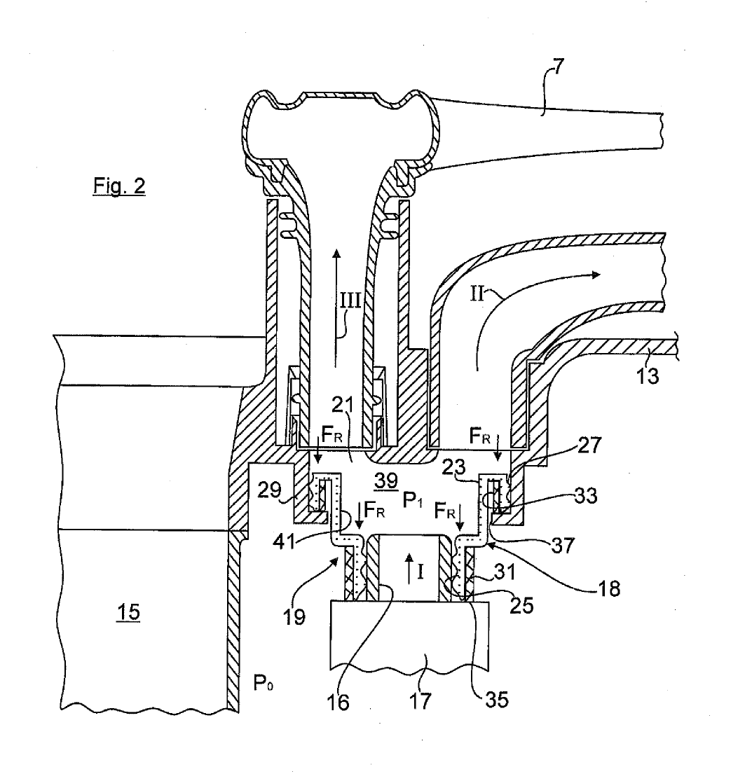

As can be seen from FIG. 2, the recirculation pump 17 with its pressure piece 16 has a liquid-tight connection via a sealing element 18 to a connection opening 21 provided in the floor 13 of the washing container. The sealing element 18 bridges a ring gap 19 between the pressure piece 16 and the connection opening 21 and is produced in the form of a hose from a soft rubber material 23. The rubber material 23 is pushed on its outer side onto the pressure piece 16 of the recirculation pump 17, so that the sealing element 18 is in sealing contact with the pressure piece 16 with a radially inner sealing point 25.

On its opposite side the sealing element 18 is in sealing contact with its radially outer side 27 with a cylindrical ring wall 29 which delimits the opening edge of the connection opening 21 in the container floor 13.

To stabilize the sealing points 25, 27, rigid ring collars 31, 33 are integrated into the rubber material 23 of the sealing element 18. The internal diameter of the lower ring collar 31 in the installed position is dimensioned so that the sealing point 25 is pressed with a predetermined compression in the radial direction against the pressure piece 16 of the recirculation pump 16. Correspondingly the outer diameter of the upper ring collar 33 in the installation position is dimensioned so that the radially outer sealing point 27 is likewise pressed with a suitable compression in the radial direction against the ring wall 29 of the connection opening 21.

As can further be seen from FIG. 2, the two sealing points 25, 27 with their assigned ring collars 31, 33 sit on ring stops 35, 37. These are respectively embodied as a ring flange facing inwards at the lower end of the ring wall 29 or as a ring shoulder expanded radially opposite the connection piece 16.

As an alternative to the exemplary embodiment shown, the recirculation pump 17 with its pressure piece 16 can also be in direct connection with the pump sump 15 of the dishwasher in flow terms. In this case the connection opening 21 is not formed directly in the dishwasher floor 13 but is embodied directly in the pump sump 15.

During dishwashing the recirculation pump 17 displaces washing liquor in the flow directions I, II, III shown in the diagram in the direction of the spray arms 7, 9. In the liquid space 39 upstream between the recirculation pump 17 and the connection opening 21 of the washing container 13, an overpressure p₁ therefore obtains by comparison with the ambient pressure p₀.

The surfaces 41 of the sealing element 18 exposed to the liquid space 39 thus have a pressure force applied to them from within. The forces F_{R} produced as a result, in accordance with FIG. 2, press the sealing element 18 with its ring collars 31, 33 as well as with its radially outer and inner sealing points 25, 27 against the ring stops 35, 37 of the connection opening 21 or of the recirculation pump 17, which assists the liquid-tight sealing between the pressure piece 16 and the connection opening 21 without additional attachment clamps being required.

The installation of the sealing element 18 between the connection opening 21 of the washing compartment floor 13 and the pressure piece 16 of the recirculation pump 17 is illustrated with reference to FIG. 3. Accordingly in a first installation step the pressure piece 16 of the recirculation pump 17 is brought into its positionally-correct installation position opposite the connection opening 21 by means of a first joining movement in a horizontal installation direction A opposite the connection opening 21 of the washing container 13. In the installation position shown in FIG. 3 the pressure piece 16 is spaced at a distance Ah in the vertical direction from the lower end of the ring wall 29 of the connection opening 21.

In a subsequent installation step the sealing element 18 is pressed with a second joining movement in a vertical installation direction B with the aid of an installation stamp 43 into the ring gap 19 between the ring wall 29 and the pressure piece 16. In this case in a joint operation the two sealing points 25, 27 of the sealing element 18 are pressed into sealing contact with the ring wall 29 of the connection opening 21 as well as with the pressure piece 16 of the recirculation pump 17. The installation stamp 43 is provided with correspondingly graduated pressure surfaces in order to make possible the offset installation position of the sealing points 25, 27 offset in accordance with FIG. 3 in installation direction B.

The two sealing points 25, 27 of the sealing element 18 are connected to each other via a bellows section 45 which makes possible such an installation-related offset between the two ring collars 31, 33 in the installation direction B. During dishwashing the bellows section 45 additionally acts as an insulation element, with which a transmission of operation-related vibrations from the recirculation pump 17 to the washing container 13 is reduced.

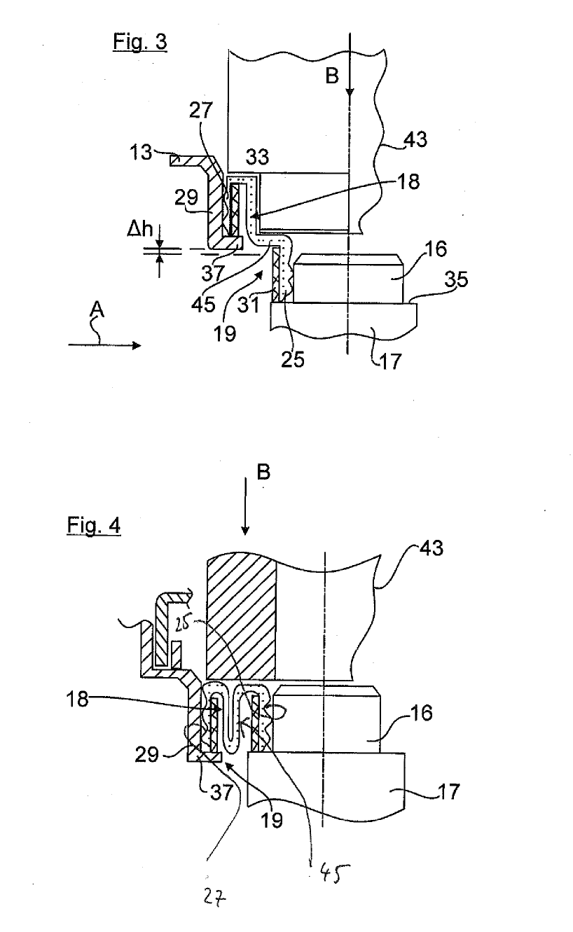

In FIG. 4 the pressure piece 16 of the recirculation pump 17 is shown in an alternative installation position, in which the pressure piece 16 projects into the connection opening 21 of the washing container. In this way the two sealing points 25, 27 are arranged in the same horizontal plane, so that the height of the seal arrangement is reduced. The insulation stamp 43 in this case, by contrast with FIG. 3, does not have any graduated pressure surfaces, but one common pressure surface with which the two sealing points 25, 27 of the sealing element 18 are pressed into the ring gap 19.

In this way an advantageous seal arrangement is provided for a dishwasher which especially seals from the pressure or wet area of the pump sump to the recirculation pump and/or other units, preferably without further clips or securing devices.

What is claimed is:

1. A seal arrangement for a liquid-tight connection of a connection opening of a liquid-conducting component to a connection piece of a liquid flow device, said seal arrangement comprising a sealing element provided in a ring gap separating the connection piece from an edge of the connection opening, said sealing element having a radially inner sealing point in sealing contact with the connection piece and a radially outer sealing point in sealing contact with the edge of the connection opening.

2. The seal arrangement of claim 1, wherein the component is a washing container of a dishwasher.

3. The seal arrangement of claim 1, wherein the liquid flow device is a recirculation pump.

4. The seal arrangement of claim 1, wherein the edge of the connection opening is delimited by a ring wall which is in sealing contact with the outer sealing point of the sealing element.

5. The seal arrangement of claim 1, further comprising at least one support element pressing the sealing element into sealing contact with the connection opening or the connection piece.

6. The seal arrangement of claim 5, wherein the support element is a ring collar.

7. The seal arrangement of claim 1, further comprising an equalization section connecting the inner and outer sealing points of the sealing element to each other.

8. The seal arrangement of claim 7, wherein the equalization section is a bellows section.

9. The seal arrangement of claim 1, wherein at least one of the edge of the connection opening and the connection piece has a movement stop on which the sealing element sits.

10. The seal arrangement of claim 9, wherein the movement stop is a ring stop.

11. The seal arrangement of claim 1, wherein the inner and outer sealing points of the sealing element are configured for being pushed in a same installation direction onto the edge of the connection opening and onto the connection piece.

12. The seal arrangement of claim 1, wherein the connection piece in an installation position projects at least partly into the connection opening of the liquid-conducting component.

13. The seal arrangement of claim 1, wherein the connection piece in an installation position is arranged at a distance outside the connection opening.

14. The seal arrangement of claim 1, wherein the sealing element is exposed to an interior space of the liquid-conducting component.

15. The seal arrangement of claim 14, wherein the interior space of the liquid-conducting component is maintained at an overpressure compared to an ambient pressure.

16. The seal arrangement of claim 1, wherein the liquid is water.

17. A method for providing a liquid-tight connection between a connection opening of a liquid-conducting component and a connection piece of a liquid flow device, said method comprising inserting a sealing element into a ring gap between an outer edge of the connection opening of the liquid-conducting component and the connection piece of the liquid flow device such that a radially inner sealing point of the sealing element is in sealing contact with the connection piece and a radially outer sealing point of the sealing element is in sealing contact with the edge of the connection opening.

18. The method of claim 17, wherein the edge of the connection opening is delimited by a ring wall, said sealing element being brought in a joint installation step with the outer sealing point of the sealing element and with the connection piece.

19. The method of claim 17, further comprising pressing the sealing element into sealing contact with the connection opening or the connection piece by at least one support element.

20. The method of claim 17, further comprising connecting the inner and outer sealing points of the sealing element to each other by an equalization section.

21. The method of claim 17, further comprising placing the sealing element on a movement stop of at least one of the edge of the connection opening and the connection piece.

22. The method of claim 17, further comprising pushing the inner and outer sealing points of the sealing element in a same installation direction onto the edge of the connection opening and onto the connection piece.

23. The method of claim 17, wherein the connection piece in an installation position projects at least partly into the connection opening of the liquid-conducting component.

24. The method of claim 17, wherein the connection piece in an installation position is arranged at a distance outside the connection opening.

25. The method of claim 17, further comprising exposing the sealing element to an interior space of the liquid-conducting component.

26. The method of claim 25, further comprising maintaining the interior space of the liquid-conducting component at an overpressure compared to an ambient pressure.

27. A dishwasher, comprising:
a liquid-conducting component having a connection opening;
a liquid flow device having a connection piece; and
at least one seal arrangement for a liquid-tight connection of the connection opening of the liquid-conducting component to the connection piece of the liquid flow device, said seal arrangement comprising a sealing element provided in a ring gap which separates the connection piece from an edge of the connection opening, said sealing element having a radially inner sealing point in sealing contact with the connection piece and a radially outer sealing point in sealing contact with the edge of the connection opening.

28. The dishwasher of claim 27, wherein the liquid-conducting component is a washing container.

29. The dishwasher of claim 27, wherein the liquid flow device is a recirculation pump.

30. The dishwasher of claim 27, wherein the liquid-conducting component has a ring wall delimiting the edge of the connection opening, said ring wall being in sealing contact with the outer sealing point of the sealing element.

31. The dishwasher of claim 27, wherein the seal arrangement includes at least one support element pressing the sealing element into sealing contact with the connection opening or the connection piece.

32. The dishwasher of claim 31, wherein the support element is a ring collar.

33. The dishwasher of claim 27, wherein the seal arrangement includes an equalization section connecting the inner and outer sealing points of the sealing element to each other.

34. The dishwasher of claim 33, wherein the equalization section is a bellows section.

35. The dishwasher of claim 27, wherein at least one of the edge of the connection opening and the connection piece has a movement stop on which the sealing element sits.

36. The dishwasher of claim 35, wherein the movement stop is a ring stop.

37. The dishwasher of claim 27, wherein the inner and outer sealing points of the sealing element are configured for being pushed in a same installation direction onto the edge of the connection opening and onto the connection piece.

38. The dishwasher of claim 27, wherein the connection piece in an installation position projects at least partly into the connection opening of the liquid-conducting component.

39. The dishwasher of claim 27, wherein the connection piece in an installation position is arranged at a distance outside the connection opening.

40. The dishwasher of claim 27, wherein the sealing element is exposed to an interior space of the liquid-conducting component.

41. The dishwasher of claim 40, wherein the interior space of the liquid-conducting component is maintained at an overpressure compared to an ambient pressure.

42. The dishwasher of claim 27, wherein the liquid is water.
